(19) United States
(12) Patent Application Publication
(10) Pub. No.: US 2006/0057877 A1
(43) Pub. Date: Mar. 16, 2006

(54) Intermodule connection in communication system

(76) Inventors: Mark A. Gill, Russiaville, IN (US); Mark A. Jackson, Kokomo, IN (US); Kerwin C. Osman, Kokomo, IN (US); Garth R. Rummery, Evanston, IL (US); Brad E. Smitley, Bunker Hill, IN (US)

Correspondence Address: DELPHI TECHNOLOGIES, INC., M/C 480-410-202, PO BOX 5052, TROY, MI, 48007, US

(21) Appl. No.: 10/940,440

(22) Filed: Sep. 14, 2004

(51) Int. Cl. H01R 13/62

(52) U.S. Cl. 439/297

(57) ABSTRACT

A connector adapter facilitates establishing mechanical and electrical connections between two connectors. The connector adapter can be slid onto either of the two connectors and, when so slid, guides insertion of the other connector. In one embodiment, the connector adapter includes an adapter base located substantially within a plane. The adapter base defines an aperture to receive a first connector body having a first connector body height. A sleeve is proximate the adapter base. At least a portion of the sleeve extends in a direction substantially normal to the plane to a distance greater than the first connector body height. The sleeve has an inner width substantially equal to an outer width of a second connector body. The connector adapter can be slid onto one of the connector bodies and guides insertion of the other connector body to facilitate alignment of the connector bodies.

### TECHNICAL FIELD

This disclosure relates generally to mobile communications. More particularly, this disclosure relates to assembly of mobile communications systems.

### BACKGROUND OF THE DISCLOSURE

The vast majority of vehicles currently in use incorporate vehicle communication systems for receiving or transmitting signals. For example, vehicle audio systems provide information and entertainment to many motorists daily. These audio systems typically include an AM/FM radio receiver that receives radio frequency (RF) signals. These RF signals are then processed and rendered as audio output. A vehicle communication system may incorporate other functions, including, but not limited to, wireless voice and data communications, global positioning system (GPS) functionality, satellite-based digital audio radio (SDAR) services, keyless entry, and remote vehicle starting.

Consumer demand has increased for vehicle communication systems that extend the functionality of vehicles beyond transportation. For instance, a growing number of consumers expect their vehicles to provide entertainment, navigation assistance, and other non-traditional automotive functions. Telematics, for example, supplements the vehicle audio system with the functionality of wireless voice and data communications and a global positioning system (GPS). By combining these functions, the vehicle communication system can provide access to communications services external to the vehicle. For example, some services may allow users to purchase tickets to sporting and cultural events from the vehicle. Emergency services may allow the vehicle communication system to automatically notify response personnel in the event of an accident and provide such personnel with the location of the vehicle. In addition, users can have their vehicle doors remotely locked or unlocked from a call center. Stolen vehicles can also be tracked using vehicle telematics.

Vehicular telematics systems typically incorporate a wireless communication module to establish voice and data communications using any of a variety of wireless communication protocols, such as, for example, various CDMA and GSM protocols. The wireless communication module is typically implemented as a circuit board that is connected to a main printed circuit board (PCB). The main PCB contains interconnects to connect the wireless communication module to various other electronic components of the vehicular telematics system.

The wireless communication module can be connected to the main PCB in a number of ways. For example, cables can be used to establish the required connections. Such cables, however, add cost to the manufacturing process. To eliminate some cables and reduce associated manufacturing costs, the wireless communication module may be connected to the main PCB via connector pins through which the wireless communication module can receive input from and provide output to other electronic components, many of which also incorporate connector pins. The pins interface with corresponding receptacles on the main PCB. Each pin is assigned to a particular input or output. Accordingly, it is essential that the pins register properly with the corresponding receptacles. Improper registration can lead to adverse effects. For example, coupling a power supply voltage to a small signal input line can overload the small signal input line. In this scenario, the pin designated for the power supply voltage input would not receive the power supply voltage, and the module would not be powered. In addition, improper registration can also cause pins to bend or break.

Some conventional wireless communication modules incorporate long alignment pins to facilitate proper registration of the pins with the corresponding receptacles. These alignment pins can properly align the wireless communication module with the main PCB. Further, the alignment pins can also align the wireless communication module and the main PCB with a casing for the vehicle telematics system. In some cases, however, the alignment pins are susceptible to bending or breaking. The alignment pins can be press-fitted to reduce the likelihood of bending or breaking, but the press-fitting process adds complexity and cost to the manufacturing process.

### SUMMARY OF VARIOUS EMBODIMENTS

According to various example embodiments, a connector adapter facilitates establishing mechanical and electrical connections between two connectors. The connector adapter can be slid onto either of the two connectors and, when so slid, guides insertion of the other connector.

In one embodiment, the connector adapter includes an adapter base located substantially within a plane. The adapter base defines an aperture to receive a first connector body having a first connector body height. A sleeve is proximate the adapter base. At least a portion of the sleeve extends in a direction substantially normal to the plane to a distance greater than the first connector body height. The sleeve has an inner width substantially equal to an outer width of a second connector body. The connector adapter can be slid onto one of the connector bodies and guides insertion of the other connector body to facilitate alignment of the connector bodies.

Another embodiment is directed to a vehicle communication system. The vehicle communication system has a first circuit. A first connector is operatively coupled to the first circuit. The first connector includes a first connector body having a first connector body height. The vehicle communication system also has a second circuit. A second connector is operatively coupled to the second circuit. The second connector includes a second connector body having an outer width. A connector adapter includes an adapter base located substantially within a plane. The adapter base defines an aperture to receive the first connector body. A sleeve is proximate the adapter base. At least a portion of the sleeve extends in a direction substantially normal to the plane to a distance greater than the first connector body height. The sleeve has an inner width substantially equal to the outer width of the second connector body. The connector adapter is configured to be slidable onto one of the first connector body and the second connector body and to guide insertion of the other connector body to facilitate alignment of the first and second connector bodies and establishment of an electrical connection between the first and second circuits.

In another embodiment, a vehicle telematics system includes a housing. A telematics subsystem is located at least partially within the housing. A telematics subsystem connector is operatively coupled to the telematics subsystem. The telematics subsystem connector includes a telematics subsystem connector body having a first connector body height. A wireless telephony subsystem is also located at least partially within the housing. A wireless telephony subsystem connector is operatively coupled to the wireless telephony subsystem. The second connector has a wireless telephony subsystem connector body having an outer width. A connector adapter includes an adapter base located substantially within a plane. The adapter base defines an aperture to receive the telematics subsystem connector body. A sleeve is proximate the adapter base. At least a portion of the sleeve extends in a direction substantially normal to the plane to a distance greater than the first connector body height. The sleeve has an inner width substantially equal to the outer width of the wireless telephony subsystem connector body. The connector adapter is configured to be slidable onto one of the telematics subsystem connector body and the wireless telephony subsystem connector body and to guide insertion of the other connector body to facilitate alignment of the telematics subsystem connector body and the wireless telephony subsystem connector body and establishment of an electrical connection between the telematics subsystem and the wireless telephony subsystem.

Various embodiments may provide certain advantages. With the connector adapter guiding insertion of the connector bodies, proper alignment of the terminals of the connectors is facilitated. Consequently, the likelihood that terminals will bend or break may be reduced. In addition, the risk of overloading data terminals with a power signal may be decreased.

Additional objects, advantages, and features will become apparent from the following description and the claims that follow, considered in conjunction with the accompanying drawings.

### BRIEF DESCRIPTION OF THE DRAWINGS

FIG. 1 is a perspective view illustrating an example vehicle telematics system according to an embodiment.

FIG. 2 is a perspective view illustrating installation of a connector adapter in a first configuration.

FIG. 3 is a perspective view illustrating installation of a connector adapter in a second configuration.

FIG. 4 is a profile view of an example implementation of the connector adapter.

### DESCRIPTION OF VARIOUS EMBODIMENTS

According to various example embodiments, a connector adapter facilitates establishing mechanical and electrical connections between two connectors. The connector adapter can be slid onto either of the two connectors and, when so slid, guides insertion of the other connector.

In one embodiment, a connector adapter includes an adapter base located substantially within a plane. The adapter base defines an aperture to receive a first connector body having a first connector body height. A sleeve is proximate the adapter base. At least a portion of the sleeve extends in a direction substantially normal to the plane to a distance greater than the first connector body height. The sleeve has an inner width substantially equal to an outer width of a second connector body. The connector adapter is configured to be slidable onto either the first connector body or the second connector body and to guide insertion of the other connector body to facilitate alignment of the first and second connector bodies.

With the connector adapter guiding insertion of the connector bodies, proper alignment of the terminals of the connectors is facilitated. Consequently, the likelihood that terminals will bend or break may be reduced. As another particular example, the risk of overloading a data terminal with a power signal may also be decreased. Similarly, proper alignment helps ensure that power terminals receive power.

In the following description, numerous specific details are set forth in order to provide a thorough understanding of various embodiments of the present invention. It will be apparent to one skilled in the art that the present invention may be practiced without some or all of these specific details. In other instances, well known components and process steps have not been described in detail in order to avoid unnecessarily obscuring the present invention.

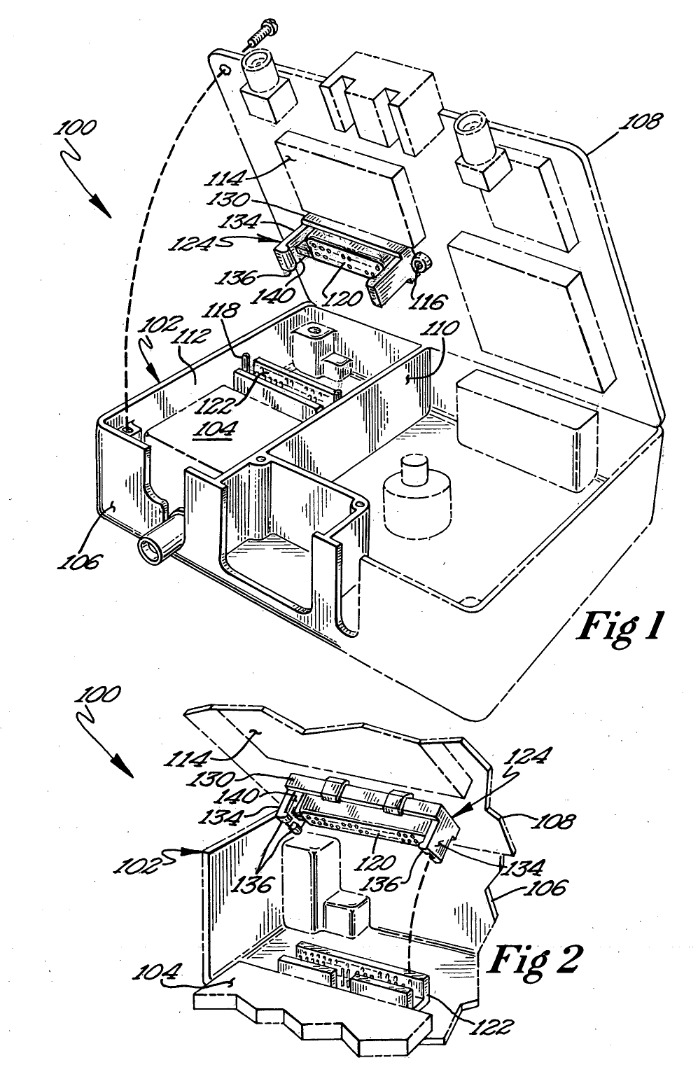

Referring now to the drawings, FIG. 1 illustrates an example vehicle telematics system 100 according to one embodiment. A housing 102 is formed from any of a variety of materials, including but not limited to, for example, die cast metal. The housing 102 is sized and configured to accommodate a wireless telephony subsystem, such as a wireless telephony module 104. As shown in FIG. 1, the housing 102 may be implemented as an open case 106 having a lid 108. The open case 106 may have a partition 110 defining a telephone compartment 112 within the open case 106. The wireless telephony module 104 is positioned within the telephone compartment 112.

A telematics subsystem 114 is implemented on a printed circuit board (PCB) that is secured in substantially fixed relation to the lid 108. The telematics subsystem 114 may incorporate a variety of functional subsystems, such as, for example, a global positioning system (GPS) receiver, a microprocessor, one or more memory modules, and the like. The PCB on which the telematics subsystem 114 is implemented may define one or more alignment holes 116 that interact with corresponding alignment pins 118 extending from a portion of the open case 106.

The telematics subsystem 114 is operatively coupled to a telematics system connector 120. The telematics system connector 120 has a connector body extending from the PCB by a distance known as the connector body height. The telematics system connector 120 has terminals, including power, ground, and signal terminals, that are in electrical communication with internal circuitry of the telematics subsystem 114. The particular internal connection scheme will depend on the particular circuitry embodying the telematics subsystem 114 and will be readily apparent to those of ordinary skill in the art upon studying the circuitry embodying the telematics subsystem 114.

The telematics system connector 120 is sized and configured to interface with a corresponding wireless telephony system connector 122 that is operatively coupled to the wireless telephony module 104. The wireless telephony system connector 122 has terminals, including power, ground, and signal terminals, that are in electrical communication with the internal circuitry of the wireless telephony module 104. The particular internal connection scheme will depend on, for example, the model of the wireless telephony module 104 and will be readily apparent to those of ordinary skill in the art upon studying the internal circuitry of the wireless telephony module 104.

A connector adapter 124 establishes an electrical and mechanical connection between the telematics subsystem connector 120 and the wireless telephony system connector 122. The connector adapter 124 may be slid on either the telematics system connector 120 or the wireless telephony system connector 122, and leads and aligns the mating telematics subsystem connector 120 and wireless telephony system connector 122. In this way, the connector adapter 124 facilitates a blind assembly to reduce or eliminate the occurrence of mis-indexed or bent pins.

FIG. 2 depicts the connector adapter 124 installed in one configuration. In the configuration illustrated in FIG. 2, the connector adapter 124 is slid on the telematics system connector 120. To facilitate sliding the connector adapter 124 on the telematics system connector 120, the connector adapter 124 has an inner width that is substantially equal to the outer width of the telematics system connector 120. With the connector adapter 124 sized in this way, the connector adapter 124 fits snugly around the telematics system connector 120 and tends to remain attached to the telematics system connector 120 during the assembly process.

The connector adapter 124 extends past the height of the telematics system connector 120 and, as a result, leads the telematics system connector 120 as it is brought into proximity to and contact with the wireless telephony system connector 122. Alignment of the telematics subsystem connector 120 and the wireless telephony system connector 122 is thus facilitated, promoting proper registration of the corresponding terminals of the telematics subsystem connector 120 and the wireless telephony system connector 122.

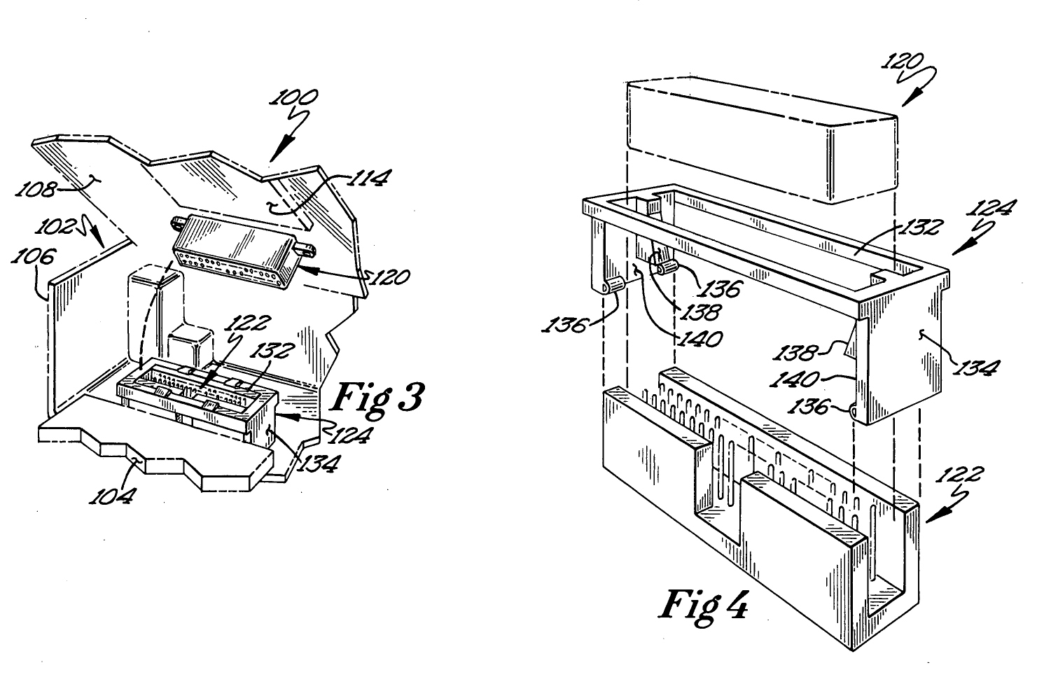

FIG. 3 illustrates installation of the connector adapter 124 in another configuration. In the configuration depicted in FIG. 3, the connector adapter 124 is slid on the wireless telephony system connector 122 rather than the telematics system connector 120. To facilitate sliding the connector adapter on the wireless telephony system connector 122, the connector adapter 124 has an inner width that is substantially equal to the outer width of the telematics system connector 120. With the connector adapter 124 sized in this way, the connector adapter 124 fits snugly around the wireless telephony system connector 122 and tends to remain attached to the wireless telephony system connector 122 during the assembly process.

The connector adapter 124 extends past the height of the wireless telephony system connector 122 and thus leads the wireless telephony system connector 122 as it is brought into proximity to and contact with the telematics system connector 120. Alignment of the telematics subsystem connector 120 and the wireless telephony system connector 122 is thus facilitated, promoting proper registration of the corresponding terminals of the telematics subsystem connector 120 and the wireless telephony system connector 122.

Advantageously, the connector adapter 124 can be used to facilitate establishment of mechanical and electrical connections between connectors manufactured by different manufacturers, provided the connectors themselves are physically compatible with one another, that is, provided that the connectors fit together. Various pairs of connectors having similar pin configurations, pin sizes, and pin pitches can be interconnected in this way.

FIG. 4 illustrates an example implementation of the connector adapter 124. The connector adapter 124 may be formed from any of a variety of materials, including, for example, a rigid or semi-rigid polymer. The connector adapter 124 includes an adapter base 130 located substantially within a plane. The adapter base 130 defines an aperture 132 that is sized to receive the telematics system connector 120 when the connector adapter 124 is slid onto the telematics system connector 120 with the adapter base 130 facing the telematics system connector 120.

A sleeve 134 is located proximate the adapter base 130. In the embodiment shown in FIG. 4, the sleeve 134 extends outward from the adapter base 130 in a direction substantially normal to the plane in which the adapter base 130 is located. The distance to which the sleeve 134 extends from the adapter base 130 is greater than the height of the telematics system connector 120, such that when the connector adapter 124 is fully slid onto the telematics system connector 120 as shown in FIG. 2, a portion of the sleeve 134 leads the leading edge of the telematics system connector 120. In this way, the connector adapter 124 guides alignment and interconnection of the telematics subsystem connector 120 and the wireless telephony system connector 122.

As shown in FIG. 3, the connector adapter 124 can be slid onto the wireless telephony system connector 122 rather than the telematics system connector 120. Accordingly, the sleeve 134 preferably extends outward from the adapter base 130 to a distance greater than the height of the wireless telephony system connector 122. In this way, when the connector adapter 124 is fully slid onto the wireless telephony system connector 122 as shown in FIG. 3, a portion of the sleeve 134 leads the leading edge of the wireless telephony system connector 122. The connector adapter 124 thus guides alignment and interconnection of the telematics subsystem connector 120 and the wireless telephony system connector 122 regardless of whether the connector adapter 124 is initially slid onto the telematics system connector 120 or onto the wireless telephony system connector 122.

The inner width of the sleeve 134 is preferably substantially equal to the outer width of the wireless telephony system connector 122. Accordingly, when the connector adapter 124 is slid over the wireless telephony system connector 122, the sleeve 134 fits snugly over the wireless telephony system connector 122.

While not required, the connector adapter 124 may incorporate various additional features to facilitate guidance and alignment of the telematics subsystem connector 120 and the wireless telephony system connector 122. For instance, rollers 136 may facilitate sliding the connector adapter 124 over the wireless telephony system connector 122. The rollers 136 may be formed, for example, from rubber or plastic. As the connector adapter 124 is slid over the wireless telephony system connector 122, the rollers 136 interact with the wireless telephony system connector 122 and guide positioning of the wireless telephony system connector 122. Inside the connector adapter 124, sloped ribs 138 projecting inward from inner surfaces 140 of the connector adapter 124 may guide insertion of the telematics system connector 120 into the connector adapter 124. If the connector adapter 124 is initially slid onto the telematics system connector 120, the sloped ribs 138 promote proper alignment between the connector adapter 124 and the telematics system connector 120.

As demonstrated by the foregoing discussion, various embodiments may provide certain advantages. For instance, with the connector adapter guiding insertion of the connector bodies, proper alignment of the terminals of the connectors is facilitated. Consequently, the likelihood that terminals will bend or break may be reduced. As another particular example, proper alignment helps ensure that power and data signals are directed to the correct power and data terminals. In this way, the risk of overloading a data terminal with a power signal may be decreased. Further, assembly time can be reduced by reducing the need to verify proper alignment between connectors.

It will be understood by those skilled in the art that various modifications and improvements may be made without departing from the spirit and scope of the disclosed embodiments. The scope of protection afforded is to be determined solely by the claims and by the breadth of interpretation allowed by law.

What is claimed is:

1. A connector adapter comprising:
an adapter base located substantially within a plane and defining an aperture to receive a first connector body having a first connector body height; and
a sleeve proximate the adapter base, at least a portion of the sleeve extending in a direction substantially normal to the plane to a distance greater than the first connector body height, the sleeve having an inner width substantially equal to an outer width of a second connector body,
wherein the connector adapter is configured to be slidable onto one of the first connector body and the second connector body and to guide insertion of the other connector body to facilitate alignment of the first and second connector bodies.

2. The connector adapter of claim 1, wherein the first connector body comprises a telematics subsystem connector.

3. The connector adapter of claim 1, wherein the second connector body comprises a wireless telephony module connector.

4. The connector adapter of claim 1, wherein the connector adapter is formed from a rigid polymer.

5. The connector adapter of claim 1, wherein the connector adapter is formed from a semi-rigid polymer.

6. The connector adapter of claim 1, wherein at least a portion of the sleeve extends in a direction substantially normal to the plane to a distance greater than a second connector body height of the second connector body.

7. The connector adapter of claim 1, further comprising a roller located proximate the sleeve and configured and arranged to interact with the second connector body to guide positioning of the second connector body.

8. The connector adapter of claim 1, further comprising a rib projecting from an inner surface of the connector adapter and configured and arranged to interact with the first connector body to guide positioning of the first connector body.

9. The connector adapter of claim 8, wherein the rib is sloped.

10. A vehicle communication system comprising:
a first circuit;
a first connector operatively coupled to the first circuit, the first connector comprising a first connector body having a first connector body height;
a second circuit;
a second connector operatively coupled to the second circuit, the second connector comprising a second connector body having an outer width; and
a connector adapter comprising
an adapter base located substantially within a plane and defining an aperture to receive the first connector body; and
a sleeve proximate the adapter base, at least a portion of the sleeve extending in a direction substantially normal to the plane to a distance greater than the first connector body height, the sleeve having an inner width substantially equal to the outer width of the second connector body,
wherein the connector adapter is configured to be slidable onto one of the first connector body and the second connector body and to guide insertion of the other connector body to facilitate alignment of the first and second connector bodies and establishment of an electrical connection between the first and second circuits.

11. The vehicle communication system of claim 10, wherein the first connector comprises a telematics subsystem connector.

12. The vehicle communication system of claim 10, wherein the second connector comprises a wireless telephony module connector.

13. The vehicle communication system of claim 10, wherein the connector adapter is formed from a rigid polymer.

14. The vehicle communication system of claim 10, wherein the connector adapter is formed from a semi-rigid polymer.

15. The vehicle communication system of claim 10, wherein at least a portion of the sleeve extends in a direction substantially normal to the plane to a distance greater than a second connector body height of the second connector body.

16. The vehicle communication system of claim 10, further comprising a roller located proximate the sleeve and configured and arranged to interact with the second connector body to guide positioning of the second connector body.

17. The vehicle communication system of claim 10, further comprising a rib projecting from an inner surface of the connector adapter and configured and arranged to interact with the first connector body to guide positioning of the first connector body.

18. The vehicle communications system of claim 19, wherein the rib is sloped.

19. A vehicle telematics system comprising:
a housing;
a telematics subsystem located at least partially within the housing;
a telematics subsystem connector operatively coupled to the telematics subsystem, the telematics subsystem connector comprising a telematics subsystem connector body having a first connector body height;
a wireless telephony subsystem located at least partially within the housing;
a wireless telephony subsystem connector operatively coupled to the wireless telephony subsystem, the wireless telephony subsystem connector comprising a wireless telephony subsystem connector body having an outer width; and
a connector adapter comprising
an adapter base located substantially within a plane and defining an aperture to receive the telematics subsystem connector body; and
a sleeve proximate the adapter base, at least a portion of the sleeve extending in a direction substantially normal to the plane to a distance greater than the first connector body height, the sleeve having an inner width substantially equal to the outer width of the wireless telephony subsystem connector body,
wherein the connector adapter is configured to be slidable onto one of the telematics subsystem connector body and the wireless telephony subsystem connector body and to guide insertion of the other connector body to facilitate alignment of the first telematics subsystem connector body and the wireless telephony subsystem connector body and establishment of an electrical connection between the telematics subsystem and the wireless telephony subsystem.

20. The telematics system of claim 19, wherein the housing is formed from a die cast metal.

21. The telematics system of claim 19, wherein the connector adapter is formed from a rigid polymer.

22. The telematics system of claim 19, wherein the connector adapter is formed from a semi-rigid polymer.

23. The telematics system of claim 19, wherein at least a portion of the sleeve extends in a direction substantially normal to the plane to a distance greater than a second connector body height of the wireless telephony subsystem connector body.

24. The telematics system of claim 19, further comprising a roller located proximate the sleeve and configured and arranged to interact with the wireless telephony subsystem connector body to guide positioning of the wireless telephony subsystem connector body.

25. The telematics system of claim 19, further comprising a rib projecting from an inner surface of the connector adapter and configured and arranged to interact with the telematics subsystem connector body to guide positioning of the telematics subsystem connector body.
